(19) United States
(12) Patent Application Publication
(10) Pub. No.: US 2004/0268258 A1
(43) Pub. Date: Dec. 30, 2004

(54) Web-based user interface for performing provisioning

(75) Inventors: Hoyong Lee, East Brunswick, NJ (US); Baekjun Lim, East Brunswick, NJ (US); Lucia C. Sekino, Holmdel, NJ (US)

Correspondence Address: SYNNESTVEDT & LECHNER, LLP, 2600 ARAMARK TOWER, 1101 MARKET STREET, PHILADELPHIA, PA, 191072950

(73) Assignee: Lucent Technolgies Inc., Murray Hill, NJ

(21) Appl. No.: 10/602,146

(22) Filed: Jun. 24, 2003

(51) Int. Cl. G09G 5/00

(52) U.S. Cl. 715/708; 715/735; 715/780; 715/854

(57) ABSTRACT

Web-based user interface for performing network provisioning. The Web-based user interface includes pages for display on a display device. Each page may include a first area containing a graphical workflow indicator that provides an ordered list of user-selectable tasks associated with performing provisioning in a network. Each page may also include a second area containing display information and/or parameter fields associated with a particular one of the user-selectable tasks. Accordingly, when a particular one of the user-selectable tasks is selected from the first area, the display information and/or parameter fields necessary to complete operations associated with the particular one of the user-selectable tasks are presented in the second area.

### TECHNICAL FIELD

The present invention relates generally to network management, and more particularly, to network management systems for provisioning network resources.

### BACKGROUND

Provisioning in the field of network management typically involves initiating and/or allocating resources between network elements in some type of network infrastructure. For instance, when creating a connection between two separate network elements, network managers (i.e., information technology (IT) personnel) perform “provisioning” by specifying an array of information to enable the two network elements to be linked within a network infrastructure. Most IT personnel rely on network management systems to perform provisioning. These network management systems are typically software-based systems that operate on a host device. Many of these systems employ user interfaces that may include maps of the network infrastructure and on-screen forms to be filled-out by IT personnel in order to perform the provisioning.

Many IT personnel complain that these systems, and in particular the user interfaces, are not user friendly. They complain that to perform tasks associated with provisioning, they typically have to complete many unrelated forms across several different screens. Additionally, to complete each form, they often find themselves having to refer back and forth between several different forms and/or maps. Accordingly, the process of entering information into current systems can often be a time-consuming, tedious, and burdensome experience for IT personnel.

Difficulties also arise because there is often an illogical and inconsistent workflow when performing various tasks associated with provisioning for a network. Additionally, there is a propensity for inexperienced IT personnel or IT personnel that are not intimately familiar with a particular network infrastructure to make mistakes when entering information into the provisioning system, which is further exasperated by having to switch (i.e., click) back and forth between forms and display screens.

### SUMMARY

A Web-based user interface for performing provisioning is described. In one exemplary implementation, the Web-based user interface includes pages for display on a display device. Each page includes a first area containing a graphical workflow indicator that provides an ordered list of user-selectable tasks associated with performing provisioning in a network. Each page also includes a second area containing display information and/or parameter fields associated with a particular one of the user-selectable tasks. Accordingly, when a particular one of the user-selectable tasks is selected from the first area, the display information and/or parameter fields necessary to complete operations associated with the particular one of the user-selectable tasks are presented in the second area.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates various components of a network management system configured to implement a Web-based user interface.

FIG. 2 shows an exemplary page associated with a Web-based user interface.

FIG. 3 shows another exemplary page associated with a Web-based user interface.

FIG. 4 illustrates a method to implement a Web-based user interface for performing provisioning in a network.

### DETAILED DESCRIPTION

Overview

To overcome inefficiencies and problems described in the Background section, the following description introduces the concept of using a graphical workflow indicator in conjunction with a Web-based user interface for performing provisioning in a network. The graphical workflow indicator appears in a set of pages associated with the user interface and guides a user through the provisioning process. The workflow indicator presents an ordered list of user-selectable tasks. Each time a user selects one of the user-selectable tasks in one area of a page, display and/or parameter fields necessary to complete operations associated with the particular user-selectable task is presented to the user in a second area of the page. Accordingly, the user is able to logically view the progression of workflow associated with provisioning in a network as well as complete all operations associated with a particular task in each particular page. As used herein, “provisioning” generally refers to managing, allocating, and initializing resources for a network using some type of network management system. For instance, provisioning may include setting-up physical links or service channels among network elements through the use of a network management system.

Exemplary Network Management System for A Web-based User Interface

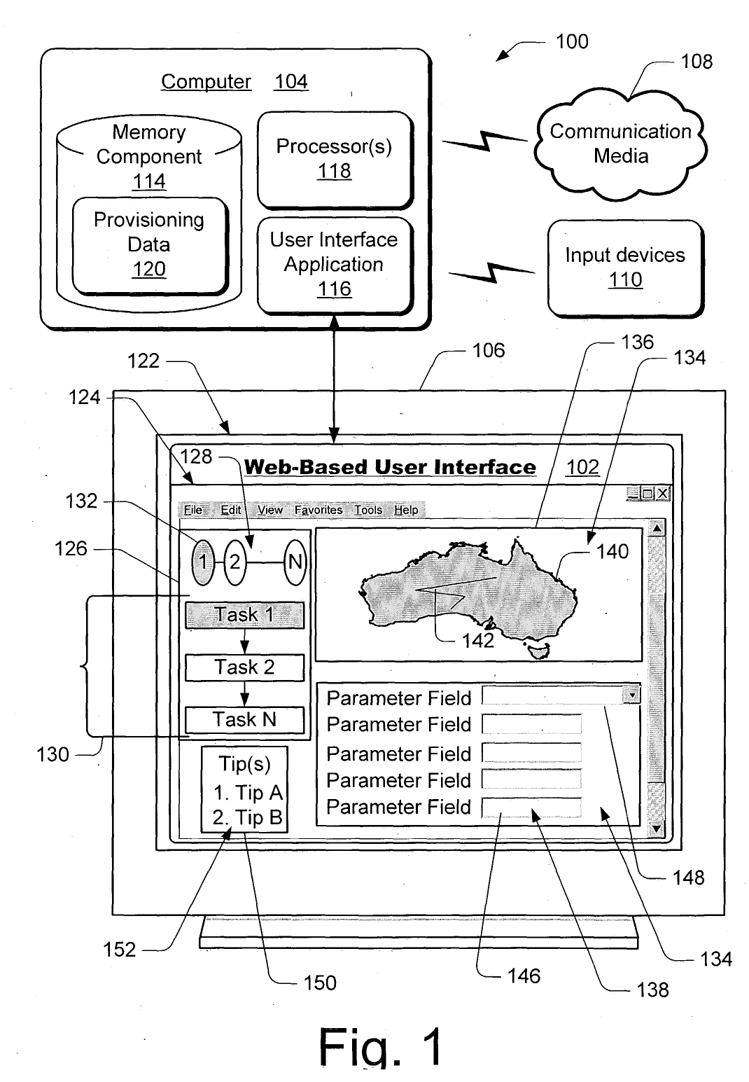

FIG. 1 illustrates various components of a network management system 100 configured to implement a Web-based user interface 102. System 100 includes a computer 104 and a display device 106. Network management system 100 may include the use of communication media 108, which includes any communication medium including networks (i.e., LAN, WAN, Internet, etc.) and point-to-point links. Accordingly, computer 104 may be configured to communicate with other devices, such as other computers (not shown) and memory devices (not shown) and to receive and/or transmit information via communication media 108.

Computer 104 can be implemented in any number of embodiments, such as a server, workstation, personal computer (PC), portable device, multiprocessor system, microprocessor-based special purpose device, application-specific integrated circuit, network PC, minicomputer, mainframe computer, or in a distributed computing environment that may include any of the above systems or devices, and the like.

In this example, computer 104 includes a memory component 114, a user interface application 116, and one or more processors 118 (e.g., any of microprocessors, controllers, and the like), which process various instructions. to control the operation of computer 104 and to communicate with other electronic and computing devices. Although not shown in this example, computer 104 may be implemented with any number and combination of differing components. For instance, other elements such as power supplies, I/O interfaces, busses, and so forth are not shown, but could easily be a part of the exemplary computer 104.

Computer 104 may receive network information including one or more portions of the user interface application 116 from other devices via communication media 108. Computer 104 may store such network information in memory component 114 as provisioning data 120 (e.g., data associated with a network or element in a network to be provisioned) or as part of the user interface application 116.

Memory component 114 may be implemented as any combination of non-volatile and volatile memory devices, including disk drives, ROMs, RAMs, flash memory, removable memory devices, optical disks, and various other memory capable of storing computer-executable instructions. Accordingly, memory component 114 includes one or more computer-readable media or computer-readable storage media.

A user can enter commands and information into computer 104 via input devices 110 such as a keyboard and a pointing device (e.g., a “mouse”). Other input devices (not shown specifically) may include a microphone, joystick, serial port, scanner, remote control device and/or the like. These and other input devices are connected to processor(s) 118 via input/output interfaces (not shown).

User interface application 116 executes on processor(s) 118 and can be stored as computer-executable instructions in non-volatile memory (not shown) as part of memory component 114. User interface application 116 is implemented to generate Web-based user interface 102 for display in a display region 122 of display device 106. Although user interface application 116 is illustrated and described as a single application configured to generate the Web-based user interface 102, user interface application 116 can be implemented as several distributed components such as in a server/client environment. In the exemplary implementation, user interface application 116 is implemented as computer-executable instructions, such as program modules, executed by one or more computers, such as computer 104. Generally, program modules include routines, programs, objects, components, data structures, etc. that perform particular data types. Typically, the functionality of the program modules may be combined or distributed as desired in various environments.

Additionally, although Web-based user interface application 116 is illustrated herein as a discrete block it is recognized that its various components may reside at various times in different storage components. User interface application 116 may also be practiced in distributed computing environments where tasks are performed by remote processing devices that are linked through communication media 108. In a distributed computing environment, program modules may be located in both local and remote computer storage media including memory storage devices. It is appreciated that user interface application 116 may have access to other programs and/or data resident within computer 104 or on other devices through various communication media 108. Thus, a portion of user interface application 116 used to generate Web-based user interface 102 may reside on one or more computers and may also coordinate with other software on computer(s) to accomplish tasks.

Web-based user interface 102 enables a user to navigate through a set of pages to perform provisioning in a network. Interface 102 is “Web-based”, because it allows a user to interact with pages using a browser, such as Microsoft's® Internet Explorer. The pages are linked together allowing a user to navigate (i.e., move) from one page to another. The arrangement of pages constitutes a part of Web-based user interface's 102 content topology. A page or a set of pages can contain or point to a variety of resources, including images, text, scripts, links to resources and so forth. Components (to be described) of user interface's 102 content may be assessable through industry standard Web protocols, such as Extensible markup language (XML), hypertext transport protocol (HTTP), and simple mail transfer protocol (SMTP), although other means of interacting with the Web-based user interface 102 may also be used, such as simple object access protocol (SOAP), remote procedure call (RPC) or object broker type technology.

A generic page 124 is shown in display area 122. Generic page 124 includes a first area 126 that contains a graphical workflow indicator 128. Graphical workflow indicator 128 includes an ordered list (1, 2, . . . , N) of user-selectable tasks 130 associated with performing provisioning in a network. A numerical indicator 132 is also displayed indicating to the user which page the user has currently selected and where within pages the task falls. For example, in the exemplary generic page 124 Task 1 is currently selected as indicated by the shading. Corresponding to Task 1 is a numeric indicator “1”, which is also shaded indicating to the user which user-selectable task is currently selected and wherein within the ordered list of possible N Tasks the user-selectable task falls. Alternatively, the numerical indicators may be implemented using other ordering such as letters (e.g., A, B, C, etc.) and/or words used to convey some type of order (e.g., “Step 1,” Step 2,” etc.).

When a user “selects” a particular user-selectable task 130, the user-selectable task contains a hypertext link to a particular page associated with performing provisioning operations associated with the task. In this case, generic page 124 is associated with performing operations associated with user-selectable Task 1. The hyperlink also may be included in the numeric indicator 132 allowing the user to navigate through the pages by selecting either the numeric indicator 132 and/or the user-selectable task 130. A user may “select” a user-selectable task by “clicking” on a designated user-selectable task 130 and/or numeric indicator 132 and being linked to a desired page or cause a task to occur. “Clicking” may be accomplished through the use of input devices 110, such as a pointing device, a mouse, joy stick, key board, remote control device, touch-screen or by some other device configured to function with computer 104, which enables input to Web-based user-interface 102.

Generic page 124 also includes a second area 134 that contains display information 136 and/or parameter fields 138 corresponding to performing operations associated with a particular one of the user-selectable tasks 130. Accordingly, when a user selects one of the user-selectable tasks 130 from the graphical workflow indicator 128, a second area 134 is presented to the user in conjunction with the graphical workflow indicator 128 in the first area 126. For purposes of discussion, the term “user-selectable task” may include the user-selectable task 130 and/or numeric indicator 132 associated with it. In one exemplary implementation, all information or parameters needed to complete operations associated with performing a user-selected task is provided in second area 134. This eliminates the need to select additional display screens and windows in order to complete a specific task.

Display information 136 may include a map 140 or other descriptive information 142 such as network links (or other network information) that a user may desire to reference or view to complete operations associated with performing a particular one of the user-selectable tasks 130. In generic page 124, user-selectable task 1 involves performing operations associated with linking network nodes in Australia. Accordingly, a map 140 of Australia is displayed in second area 134 corresponding to Task 1. Map 140 includes links 142 between various nodes in a network.

Parameter fields 138 include boxes 146 and pull-down menus 148, which permit a user to enter information or view certain information. For instance, boxes 146 provide location on page 124 in which a user may enter information appurtenant to a user-selectable task. Pull-down menus 148 may include a list of items that may be viewed and selected by the user appurtenant to a user-selectable task. Parameter fields 138 may include other Web-page information including, but not limited to, text, menus, buttons, check boxes, comment fields, sub-windows, forms, submenus, dates, and other information that may be viewed and/or manipulated by the user, all of which may be appurtenant to a user selectable task 130.

Generic page 124 may also include a third area 150 that contains one or more tips 152, such as Tip A and Tip B. Each tip is presented to user in conjunction with a particular one of the user-selectable tasks selected to assist in completing one of the user-selectable tasks selected by the user. In other words, each tip provides guidance or instruction to the user enabling the user to complete operations in the second area 134.

User interface application 116 renders each of the areas 126, 134, and 150. Although only these three areas are shown on the generic page 124, additional areas may be presented. Additionally, it is possible that the tip areas 150 may not be rendered in one or more pages. It is also appreciated that Web-based user interface 102 may include other pages dispersed between one or more pages (such as generic page 124) that does not include a graphical workflow indicator 128 or other elements described with reference to generic page 124.

Once a user has completed operations associated with a particular user-selectable task 130 such as Task 1, the user may perform another one of the tasks by selecting another user-selectable task 130, such as Task 2, until all the tasks (e.g., Tasks 1-N) are completed. The user may also select tasks in any order the user desires, which may include performing various user-selectable tasks out of order or involve returning to a previously completed task. When a user selects another task, a new page is displayed which typically includes workflow indicator 128 and second area 134 that contains display information 136 and/or parameter fields 138 corresponding to performing operations associated with a particular one of the user-selectable tasks 130.

As mentioned above, current procedures typically require users of network management systems to open many separate windows and click back and forth in order to complete them. In generic page 124, a user is able perform all operations associated with a particular task by simply clicking on a user-selectable task 130 in workflow indicator 128 and performing operations associated with that task in second area 134. This not only reduces the number of necessary clicks, but provides for a much more friendly workflow and user interface. Additionally, by providing all necessary information and parameters in the second area 134 which are associated with the particular task (e.g., Task 1) in the first area 126, Web-based user interface 102 reduces the possibilities of making a mistake while entering provisioning information.

It is noted that FIG. 1 is not drawn to scale. The positioning, style, and sizes of the elements shown in display area 122 may vary and should not be construed as a limitation. Additionally, the content shown in display area 122 will vary depending on the provisioning application, user-selectable task 130 selected by the user, and the actual network or elements being provisioned.

Having introduced the general concepts of using a Web-based user interface to perform provisioning in a network with reference to exemplary generic page 124, it is now possible to illustrate other exemplary pages of a Web-based user interface.

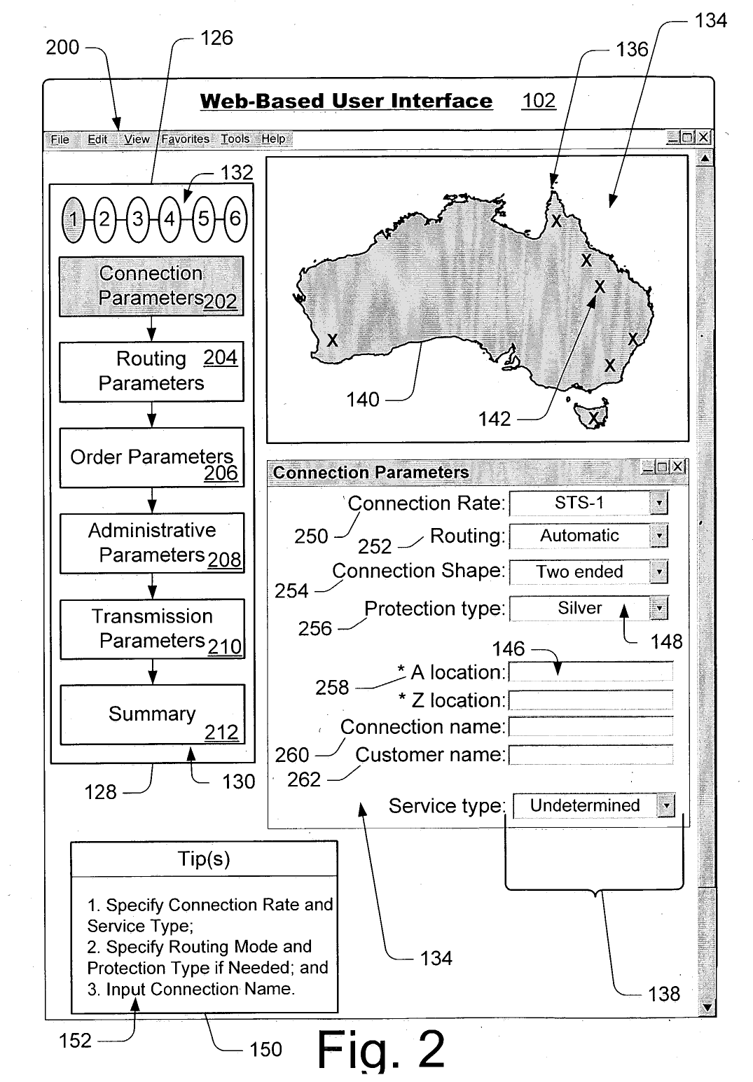

In particular, FIG. 2 shows an exemplary page 200 associated with a Web-based user interface 102. Page 200 is similar to page 124 described above. Like page 124, page 200 includes a first area 126 that contains a graphical workflow indicator 128. Graphical workflow indicator 128 includes an ordered list of user-selectable tasks 130 associated with performing provisioning in a network. In this example, the tasks include: connection parameters 202; routing parameters 204; order parameters 206; administrative parameters 208; transmission parameters 210; and a summary task 212. Numerical indicator 132 is also displayed indicating to the user which page the user has currently selected and where within six pages the task falls. For example, in page 200 “Connection parameters” 202 is currently selected as indicated by the shading. Corresponding to connection parameters 202 is a numeric indicator “1”, which also is shaded indicating to the user which user-selectable task is currently selected out of six possible user-selectable tasks in this example. Of course, other quantities of user-selectable tasks, greater or smaller, could be used.

Page 200 also includes a second area 134 that contains display information 136 and or parameter fields 138 corresponding to performing operations associated with a user selectable task, e.g., connection parameter 202. Accordingly information and parameters needed to complete operations associated with establishing connection parameters is provided in second area 134. This eliminates the need to select additional display screens and windows to complete a specific task.

Display information 136 includes a map 140 of Australia and network nodes 142 comprising a particular network within Australia. Parameter fields 138 include boxes 146 and pull-down menus 148, permitting a user to enter information or view certain information associated with connection parameters 202, such as a connection rate 250, type of routing (e.g., automatic or manual) 252, connection shape 254, protection type 256, port selections 258, connection name 260, and customer name 262.

Page 200 also includes a third area 150 that contains tips 152 associated with connection parameters 202. In this example, three tips are enumerated, however, other quantities of tips, greater or smaller, could be presented to the user.

Once a user has completed entering information or viewing information in page 200, the user may perform a next user-selectable task associated with provisioning by clicking on either one of the numerical indicators 132 associated with the task the user is interested in performing, or by clicking on the actual text description associated with one of the user-selectable tasks 130. For example, the user may desire to perform the next task in this example, which is “routing parameters” 204.

It is noted that FIG. 2 is not drawn to scale. The positioning, style, and sizes of the elements shown in display area for page 200 may vary and should not be construed as a limitation. Additionally, the content shown on page 200 will vary depending on the provisioning application, user-selectable task selected by the user, and the actual network or elements being provisioned.

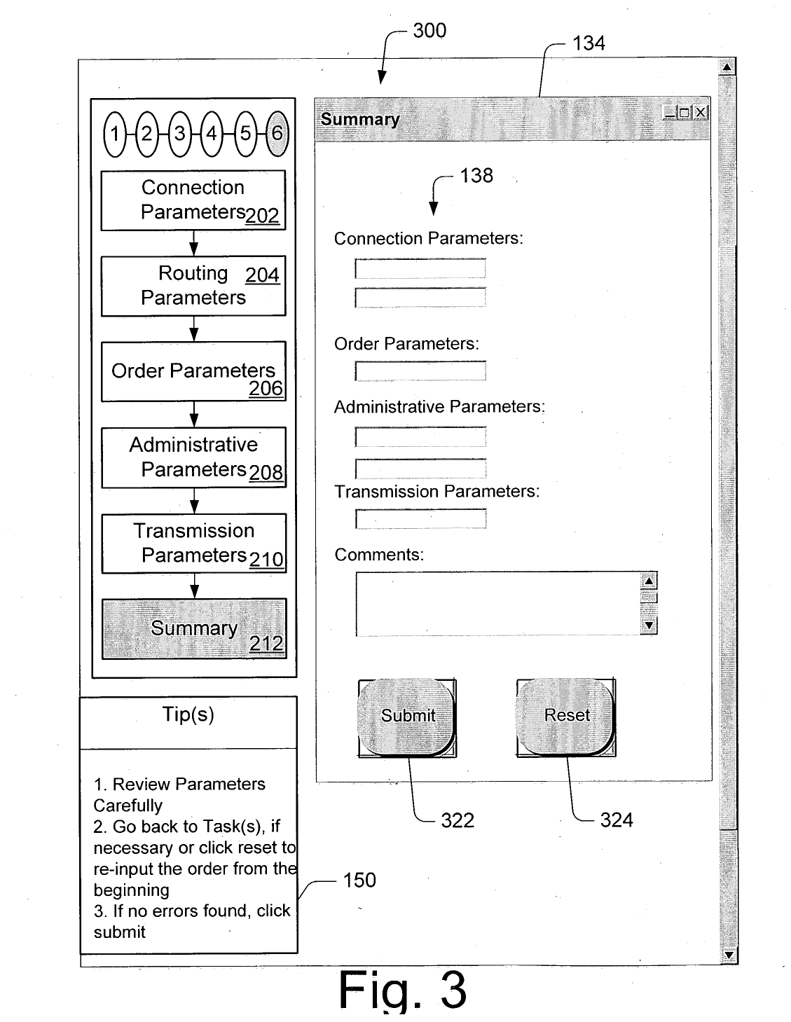

FIG. 3 shows an exemplary summary page 300 that a user may select to verify that information entered in previous pages is correct before submitting the information to the system for further processing. Summary page 300 is presented to a user when the user selects summary task 212. For example, in page 300 “Summary” task 212 is currently selected as indicated by the shading. Corresponding to summary task 212 is a numeric indicator “6”, which is also shaded indicating to the user which user-selectable task is currently being rendered out of six possible user-selectable tasks in this example.

On page 300, second area 134 only includes parameter fields 138 associated with all previous user-selectable tasks performed by the user. In other words, second area 134 does not include display information 136 such as a map. The user is able to carefully review the parameter fields 138 at the user's own pace, and correct any errors by clicking on the user-selectable task associated with a particular parameter and going back to a particular page to reenter the information. Alternatively, the user may correct the information contained in any of the boxes or pull-down menus, etc. presented in page 300. Once the user is satisfied that all information in the second area is correct 134, the user may select submit button 322, to submit the information to network management system for further processing. If the user is dissatisfied with the information, he also has the option to select a reset button 324 and start the provisioning process over with page 200 (FIG. 2).

It is noted that FIG. 3 is not drawn to scale. The positioning, style, and sizes of the elements shown in display area for page 300 may vary and should not be construed as a limitation. Additionally, the content shown on page 300 will vary depending on the provisioning application, user-selectable task selected by the user, and the actual network or elements being provisioned.

Methods for A Web-based User Interface for Provisioning in a Network

Methods for a Web-based User Interface may be described in the general context of computer-executable instructions. Generally, computer-executable instructions include routines, programs, objects, components, data structures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

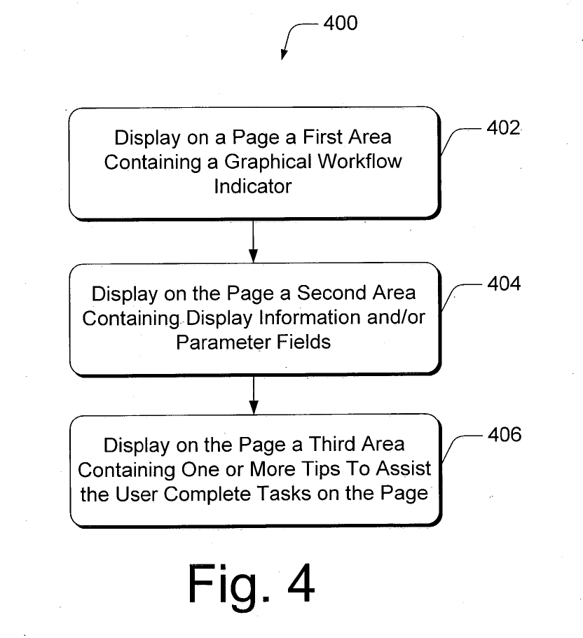

FIG. 4 illustrates a method 400 to implement a Web-based user interface for performing provisioning in a network. The order in which the method is described is not intended to be construed as a limitation, and any number of the described method blocks can be combined in any order to implement the method. Furthermore, the method can be implemented in any suitable hardware, software, firmware, or combinations thereof.

At block 402, a page associated with the content of the Web-based user interface is presented to a user on a display device. The page includes a first area, which contains a graphical workflow indicator. The graphical workflow indicator provides an ordered list of user-selectable tasks associated with performing provisioning in the network. For example, Web-based user interface 102 via user interface application 116, renders a first area 126 of pages 100 (FIG. 1), 200 (FIG. 2) and -300 (FIG. 3) that contain a graphical workflow indicator 128. Graphical workflow indicator 128 includes an ordered list (1, 2, . . . , N) of user-selectable tasks 130 associated with performing provisioning in a network. A numerical indicator 132 also may be displayed indicating to the user which page the user has currently selected and where within pages the task falls. User-selectable task 130 contains a hypertext link to a particular page associated with performing provisioning operations associated with the task. The hyperlink may also be included in the numeric indicator 132 allowing the user to navigate through the pages by selecting either the numeric indicator 132 and/or the user-selectable task 130. A user may “select” a user-selectable task by “clicking” on a designated user-selectable task 130 and/or numeric indicator 132 and being linked to a desired page or cause a task to occur.

At block 404, a second area containing display information and/or parameter fields associated with a particular one of the user-selectable tasks is rendered on a page. Accordingly, when a particular one of the user-selectable tasks is selected from the first area, display information and/or parameter fields necessary to complete operations associated with the particular one of the user-selectable tasks are presented in the second area. For example, Web-based user interface 102 via user interface application 116, renders a second area 134 on pages 100 (FIG. 1), 200 (FIG. 2) and 300 (FIG. 3). Second area 134 includes display information 136 and/or parameter fields 138 corresponding to performing operations associated with a particular one of the user-selectable tasks 130.

At block 406, a third area containing tips or guidance associated with a particular one of the user-selectable tasks is rendered on a page. Accordingly, a user may refer to the third area for step-by-step assistance in completing operations associated with a user-selectable task on the page. For example, Web-based user interface 102 via user interface application 116, renders a third area 150 on pages 100 (FIG. 1), 200 (FIG. 2) and 300 (FIG. 3). Third area 150 that contains one or more tips presented to a user in conjunction with a particular one of the user-selectable tasks selected to assist in completing one of the user-selectable tasks selected by the user. It is envisioned that the third area is optional and may be minimized by more experienced users of Web-based user interface 102.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. One or more computer-readable media comprising computer executable instructions that, when executed, direct a computer to:
display Web-based pages on a display device, each Web-based display page comprising:
a first area containing a graphical workflow indicator that provides an ordered list of user-selectable tasks associated with performing provisioning in a network; and
a second area containing display information and/or parameter fields associated with a particular one of the user-selectable tasks, such that when a particular one of the user-selectable tasks is selected from the first area, information and/or parameter fields necessary to complete operations associated with the particular one of the user-selectable tasks are presented in the second area.

2. One or more computer-readable media as recited in claim 1, wherein each of the user-selectable tasks contains a hypertext link to a particular one of the pages to enable a user to navigate through the ordered list of user selectable tasks associated with performing the provisioning of the network.

3. One or more computer-readable media as recited in claim 1, wherein the graphical workflow indicator includes a numeric indicator configured to specify (i) which user-selectable task is currently selected by the user, and (ii) where within the ordered list the user-selectable task falls.

4. One or more computer-readable media as recited in claim 1, wherein the display information includes a map of a network.

5. One or more computer-readable media as recited in claim 1, wherein the parameter fields are configured to display information entered by a user.

6. One or more computer-readable media as recited in claim 1, wherein the parameter fields are configured to provide locations to receive information entered by a user, the information being appurtenant to the user-selectable task.

7. One or more computer-readable media as recited in claim 1, further comprising computer executable instructions that, when executed, direct the computer to: display a third area simultaneously with the first and second areas, the third area including at least one tip presented to a user to assist in completing one of the user-selectable tasks selected by the user.

8. One or more computer-readable media comprising computer executable instructions that, when executed, direct a computer to: display a Web-based user interface associated with performing provisioning in a network, the Web-based user interface comprising pages including a first area having a graphical workflow indicator that provides an ordered list of user-selectable tasks associated with performing the provisioning.

9. One or more computer-readable media as recited in claim 8, further comprising computer executable instructions that, when executed direct the computer to: display a second area simultaneously with the first area on at least a portion of the pages, the second area containing display information and/or parameter fields with content necessary to complete operations corresponding to a particular one of the user-selectable tasks from the first area.

10. One or more computer-readable media as recited in claim 8, wherein each of the user-selectable tasks contains a hypertext link to a particular one of the pages to enable a user to navigate through the ordered list of user selectable tasks associated with performing the provisioning of the network.

11. One or more computer-readable media as recited in claim 8, further comprising computer executable instructions that, when executed direct a computer to: display a tip area in conjunction with graphical workflow indicator on at least a portion of the pages, the tip area including an instruction that is associated with assisting the user to perform one of the user-selectable tasks.

12. A system, comprising: a memory comprising a set of computer-executable instructions; and a processor coupled to the memory, the processor configured to execute the computer-executable instructions for displaying Web-based pages on a display device, each Web-based display page comprising:
a first area containing a graphical workflow indicator that provides an ordered list of user-selectable tasks associated with performing provisioning in a network; and
a second area containing display information and/or parameter fields associated with a particular one of the user-selectable tasks, such that when a particular one of the user-selectable tasks is selected from the first area, the display information and/or parameter fields necessary to complete operations associated with the particular one of the user-selectable tasks are presented in the second area.

13. The system as recited in claim 12, wherein each of the user-selectable tasks contains a hypertext link to a particular one of the Web-based pages and enables navigation through the ordered list of user selectable tasks associated with performing the provisioning of the network.

14. The system as recited in claim 12, wherein the graphical workflow indicator includes a numeric indicator configured to specify (i) which user-selectable task is currently selected by the user, and (ii) where within the ordered list the user-selectable task falls.

15. The system as recited as recited in claim 12, wherein the display information includes a map of a network.

16. The system as recited in claim 12, wherein the parameter fields are configured to display information entered by a user.

17. The system as recited in claim 12, wherein the parameter fields are configured to provide locations to receive information entered by a user, the information being appurtenant to the user-selectable task.

18. A method for displaying Web-based pages on a display device, comprising:
displaying on each Web-based display page a first area containing a graphical workflow indicator that provides an ordered list of user-selectable tasks associated with performing provisioning in a network;
displaying on each Web-based display page a second area containing display information and/or parameter fields associated with a particular one of the user-selectable tasks, such that when a particular one of the user-selectable tasks is selected from the first area, the display information and/or parameter fields necessary to complete operations associated with the particular one of the user-selectable tasks are rendered in the second area.

19. The method as recited in claim 18, wherein each of the user-selectable tasks contains a hypertext link to a particular one of the pages to enable a user to navigate through the ordered list of user selectable tasks associated with performing the provisioning of the network.

20. The method as recited in claim 18, wherein the graphical workflow indicator includes a numeric indicator configured to specify (i) which user-selectable task is currently selected by the user, and (ii) where within the ordered list the user-selectable task falls.

21. The method as recited in claim 18, wherein the display information includes a map of a network.

22. The method as recited in claim 18, wherein the parameter fields are configured to display information entered by a user.

23. The method as recited in claim 18, wherein the parameter fields are configured to provide locations to receive information entered by a user, the information being appurtenant to the user-selectable task.

24. The method as recited in claim 18, further comprising displaying a third area simultaneously with the first and second areas, the third area including at least one tip presented to a user to assist in completing one of the user-selectable tasks selected by the user.
